(19) United States
(12) Patent Application Publication
(10) Pub. No.: US 2025/0362384 A1
(43) Pub. Date: Nov. 27, 2025

(54) METHOD FOR SEPARATING RADAR TARGETS OF A RADAR SENSOR

(71) Applicant: Continental Automotive Technologies GmbH, Hannover (DE)

(72) Inventors: Thomas Jost, Gilching (DE); Andreas Koch, Oelde (DE); Daniel Wallner, Sinzing (DE)

(73) Assignee: Continental Automotive Technologies GmbH, Hannover (DE)

(21) Appl. No.: 19/218,280

(22) Filed: May 25, 2025

(30) Foreign Application Priority Data
May 27, 2024 (DE) 10 2024 204 898.4

(51) Int. Cl. G01S 7/41; G01S 13/00

(52) U.S. Cl. CPC G01S 7/412; G01S 13/006

(57) ABSTRACT

A method for the model-based, high-resolution separation of radar targets for a radar sensor, in which the radar sensor initially generates radar data by capturing radar targets by sampling a field of view of the radar sensor. Various model orders are calculated for the number of radar targets with the aid of a grid-based method and are interleaved in one another. A highest model order is specified, and only the highest model order is calculated, so that the lower model calculations are implicitly produced from the calculation of the highest model order.

### TECHNICAL FIELD

A method for separating radar targets of a radar sensor in which an efficient calculation of high-resolution methods for multiple model orders is carried out, as well as a radar sensor in which radar targets are separated with the aid of the method are described.

### BACKGROUND

Conventional radar resolution, that is to say the separation of various targets, is limited by processing via a beamformer, wherein said beamformer performs a Fourier calculation as a general rule. In order to increase the resolution, various model-based methods have been developed which are based, e.g., on a so-called “Maximum Likelihood” as a criterion or a projection onto subspaces. Various methods are outlined, for example, by Krim, Hamid & Viberg, Mats (1996) in “Two Decades of Array Signal Processing Research: The Parametric Approach” (Signal Processing Magazine, IEEE. 13. 67-94. 10.1109/79.526899) or Sun, Shunqiao & Petropulu, Athina & Poor, H. Vincent (2020) in “MIMO Radar for Advanced Driver-Assistance Systems and Autonomous Driving: Advantages and Challenges” (IEEE Signal Processing Magazine. 37. 98-117. 10.1109/MSP.2020.2978507). The approaches based on maximum likelihood, which provide a better separation of targets compared to subspace-based methods, are preferred due to the better statistical performance. As a general rule, the maximum likelihood methods are based on the model

$$z = {\sum }_{l = 0}^{N - 1} a ( {θ}_{l} ) {α}_{l} + n \qquad Equation ( 1 )$$

wherein z denotes the incoming sample data (or the sampling values), a(θₗ) denotes a non-linear function depending on the parameter θₗ, with complex amplitude αₗ, and n denotes a noise vector with complex Gaussian distribution. In this case, equation (1) can also be written in matrix form as

$$z = A ( θ ) α + n \qquad Equation ( 2 )$$

$$wherein$$

$$A ( θ ) = [ a ( {θ}_{0} ) , … , a ( {θ}_{N - 1} ) ]$$

$$α = {[ {α}_{0} , … , {α}_{N - 1} ]}^{T}$$

Applying the teaching of G. H. Golub & Victor Pereyra (1973) in “The Differentiation of Pseudo-Inverses and Nonlinear Least Squares Problems Whose Variables Separate” (SIAM Journal on Numerical Analysis 10.413-432.10.1137/0710036), a concentrated solution is produced for equation 2 as

$$\hat{θ} = min [ {z}^{H} z - {z}^{H} A {( {A}^{H} A )}^{- 1} {A}^{H} z ] \qquad Equation ( 3 )$$

wherein the mean square error m(\hat{θ}) is inherently calculated as

$$m ( \hat{θ} ) = {z}^{H} z - {z}^{H} A {( {A}^{H} A )}^{- 1} {A}^{H} z \qquad Equation ( 4 )$$

Equation (3) is mostly solved by iterative optimization approaches. However, the optimization can also be solved by a grid-based method, wherein the solution space is depicted by grid points (sampling points) and the extreme point can be found by a simple search. In this case, it should be noted that equation (3) depends on the meta parameter N of the model order. If this is unknown, equation (3) must, as a general rule, be calculated for multiple values of N. A model detection can then be performed, e.g., by means of various information criteria using the mean square error m(\hat{θ}), as described by Petre Stoica & Yngve Selén (2004) in “Model-order selection: A review of information criterion rules” (Signal Processing Magazine, IEEE. 21. 36-47.10.1109/MSP.2004.1311138). However, in the case of the prior art described, a separate optimization has to be performed for each model or each model order. Accordingly, this increases the computational effort if, e.g., multiple models are to be tested against one another.

Starting from this, a method for separating radar targets of a radar sensor which can improve the efficiency and reduce the computation requirement is useful.

### SUMMARY

In the case of the method for the model-based, high-resolution separation of radar targets for a radar sensor, the radar sensor initially generates radar data by capturing radar targets by sampling a field of view of the radar sensor. In this case, the radar sensor transmits electromagnetic waves which are reflected by objects in the field of view and received by the radar sensor again as detections or radar targets. Furthermore, various model orders, e.g., N=1, N=2, N=3 . . . , are calculated for the number of radar targets with the aid of a grid-based method, wherein the model orders are interleaved in one another, i.e., a lower model order can be represented by a higher one or the lower model order is produced from the higher model order. In addition, a highest model order is specified, e.g., empirically, with the aid of estimates or by the number of samples, wherein only the highest model order is calculated and the lower model calculations are implicitly produced as partial results from said calculation for the highest model order, i.e., are also calculated in the calculation as interim results. The fact that only the highest model order is calculated and the lower model orders are produced, so to speak, as interim results from the calculation means that storage and computing capacity can be saved to an extent. It is subsequently indicated by the model order how many radar targets are present in order to achieve a separation of said radar targets.

The term “high-resolution” may refer to the fact that the calculation is carried out by means of mathematical models. In contrast, a conventional separation with the aid of a beamformer, the resolution limit of which is determined by the number of antennas, is not high-resolution. Accordingly, a high-resolution separation is no longer based on a beamformer, the resolution limit of which is limited by the antenna number or aperture size.

Furthermore, a “grid-based” method may comprise a sampling of the mathematical solution space, i.e., a grid is provided, wherein a sampling or grid point stands for a value of a parameter (e.g., the parameter could be the range and the value of the parameter could be 1 to N meters for N=1, . . . N=2, N=3, etc.). The grid points of the grid may be regularly distributed, wherein the values or elements of w can be pre-calculated as a vector of the length L. In this case, the pre-calculation can be carried out, e.g., by means of a discrete Fourier transform (DFT) matrix or a fast Fourier transform (FFT).

The model order may be utilized in order to indicate a number of radar targets.

Furthermore, the calculation of a model order can be utilized as a cost function, so that a cost function exists for each model order.

A maximum of the grid points may be established with the aid of the cost function. In this case, a post-processing of the maximum can also be carried out, e.g., by means of interpolation. The model order may then be selected with the aid of the interpolated maxima. Alternatively, the maximum (including, possibly, without a post-processing step or without interpolation) could also be selected with the largest value.

Furthermore, pre-calculated values or elements can be stored in a table, for example a look-up table.

Moreover, a simplified function for cyclical vectors can be stored in a table, for example a look-up table.

Furthermore, a radar sensor for detecting objects for a motor vehicle, can capture objects in its field of view with the aid of radar targets, wherein the captured radar targets are separated in accordance with a method described herein.

The method may be executed, for example, on a computer or a computing unit of the radar sensor. A computer program can be provided with program code for performing the method or the algorithm, wherein the method is executed, e.g., when the computer program is executed on a computer or another programmable computer known from the prior art. The computer can be configured as a control device of the radar sensor or as a part of the control device (e.g., as an IC (Integrated Circuit) component, SoC (System-on-Chip) or microcontroller or the like). Furthermore, the method could also be executed or retrofitted in existing systems as a computer-implemented method. To this end, a computer-readable storage medium can be advantageously provided on which the algorithm or the program or the method is deposited. The term “computer-implemented method” may describe the sequencing or the method steps or the procedure which is realized or performed with the aid of the computer, wherein the computer can process the corresponding data by means of programmable calculation rules.

### BRIEF DESCRIPTION OF THE DRAWINGS

The present disclosure will become more fully understood from the detailed description and the accompanying drawings, wherein:

FIG. 1 shows an exemplary configuration of an algorithm for a method for separation of radar targets for a radar sensor.

### DETAILED DESCRIPTION

The invention is described in more detail below with the aid of expedient embodiments. In the case of the method, the extreme point searches for subordinate model orders can be produced as auxiliary calculations of the calculation for the highest model order with the aid of a grid-based approach. This can save computing time to an extent. The calculation of the optimal solution of the parameter \hat{θ}, based on a grid method or grid-based method, can be simplified for multiple interleaved model orders with the algorithm described, so that fewer calculations are required. In this case, only the highest model order has to be calculated, wherein lower model orders can be produced or can be calculated by means of interim results. To this end, equation (3) can be reformulated, so that

$$\begin{matrix}\hat{θ} = min m ( θ ) = max [ {z}^{H} {A ( {A}^{H} A )}^{- 1} {A}^{H} z ] \\ = max [ {w}^{H} {D}^{- 1} w ] = max [ {‖ {U}^{- H} w ‖}^{2} ]\end{matrix} \qquad Equation ( 5 )$$

$$wherein$$

$${U}^{H} U = D and {A}^{H} z = w \qquad Equation ( 6 )$$

and U denotes the upper triangular matrix of the Cholesky decomposition of A^{H}A. It should be noted that U^{-H} denotes a lower triangular matrix.

On the understanding that the solutions for the parameter \hat{θ} are established by means of a uniform grid-based method and the models are interleaved in one another, i.e., a lower model order can be represented by a higher one (see Equation (1), wherein z where N=1 is equivalent to z where N=2, if α₁=0), only the highest model order has to be calculated with the method—lower model orders are produced, e.g., by means of interim results, i.e., implicitly.

If the grid points are regularly distributed, that is to say the same sampling points k₀, . . . , k_{L-1} are used for each element of θ, the elements of w can be pre-calculated as a correlation function as a vector of the length L:

$${w}_{L} = {[ {w}_{0} , {w}_{1} , … , {w}_{L - 1} ]}^{T} = {[ a ( {k}_{0} ) , … , a ( {k}_{L - 1} ) ]}^{H} z \qquad Equation ( 7 )$$

In order to calculate m(ϑ) for a specific grid point ϑ, U^{-H}w has to be calculated, wherein w can be constructed directly from the corresponding elements of wᵢ. The lower triangular matrix U^{-H} may be structured such that the submatrix U_{n×n}^{-H} comprises the first n lines and columns of U^{-H} and is sufficient to calculate the nth model, that is to say N=n. For example, this produces:

$${U}_{3 \times 3}^{- H} = [ \begin{matrix}{u}_{11} & 0 & 0 \\ {u}_{21} & {u}_{22} & 0 \\ {u}_{31} & {u}_{32} & {u}_{33}\end{matrix} ] = [ \begin{matrix} & & 0 \\ & {U}_{2 \times 2}^{- H} & 0 \\ {u}_{31} & {u}_{32} & {u}_{33}\end{matrix} ] \qquad Equation ( 8 )$$

so that the following cost functions m(ϑ) are produced for the tuple ϑ=[kₗ, kₘ]^{T} where N=2 and the group of three ϑ=[kₗ, kₘ, kₙ]T where N=3:

$${‖ {{U}_{2 \times 2}^{- H} [ {w}_{l} , {w}_{m} ]}^{T} ‖}^{2} = {‖ {[ {u}_{11} {w}_{l} , {u}_{21} {w}_{l} + {u}_{22} {w}_{m} ]}^{T} ‖}^{2} for N = 2 \qquad Equation ( 9 )$$

$${‖ {{U}_{3 \times 3}^{- H} [ {w}_{1} , {w}_{m} , {w}_{n} ]}^{T} ‖}^{2} = {‖ [ \begin{matrix}{{U}_{2 \times 2}^{- H} [ {w}_{l} , {w}_{m} ]}^{T} \\ {u}_{31} {w}_{l} , {u}_{32} {w}_{m} + {u}_{33} {w}_{n}\end{matrix} ] ‖}^{2} for N = 3 \qquad Equation ( 10 )$$

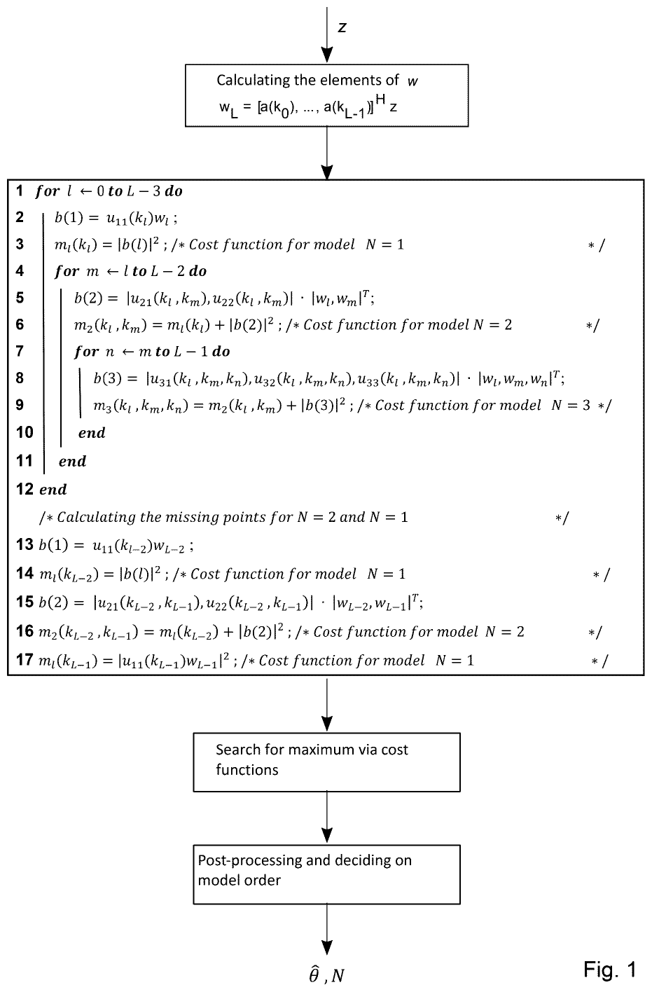

A configuration of the algorithm or of the course of the method is depicted in FIG. 1 with a calculation example, wherein a calculation of the correlation function is initially carried out for the incoming radar data or sample data for the sampling points kᵢ, i=0, . . . , L−1 in a first step. Thereafter, the algorithm described above for calculating the cost function is performed, e.g., for N=1, N=2, N=3 and the like. The maximum can subsequently be sought via the cost functions. Furthermore, a post-processing of the maximum can subsequently be carried out, e.g., by means of interpolation, in an optional step, and a decision can be made for the parameter \hat{θ} and N, for example via known methods such as, e.g., information criteria.

Furthermore, the method can be enlisted in the case of all high-resolution model-based methods in the field of radio waves, wherein this concerns radar methods and the localization of objects in particular. The method is particularly computationally efficient if the corresponding values for [a(k₀), . . . , a(k_{L-1})]^{H} [a(k₀), . . . , a(k_{L-1})]^{H} and for U^{-h} are pre-calculated externally and saved, e.g., as a look-up table. This can in turn save memory, as the elements of U^{-H} have repetitions. Moreover, in the event that a(k) is cyclically periodic, a(kᵢ)^{H}a(kⱼ)=ƒ(kⱼ−kᵢ) can be depicted by a simplified function, which is only defined by the interval kⱼ−kᵢ, which makes it easier to calculate the coefficients U^{-H} analytically. Furthermore, this configuration can make it possible to save memory for the look-up table. If a higher resolution of the solution than the given grid points is to be achieved, the cost function of the optimization or of the mean square error m(\hat{θ}) can also be interpolated via a parabolic approach, which can then be performed again individually for each model order.

1. A method for separation of radar targets for a radar sensor comprising:
generating radar data by capturing radar targets by sampling a field of view of the radar sensor;
calculating various model orders for a number of radar targets with a grid-based method, wherein the model orders are interleaved in one another;
specifying a highest model order; and
calculating the highest model order only, wherein results for the lower model orders are produced as partial results of the calculation for the highest model order.

2. The method according to claim 1, further comprising:
providing a grid for the grid-based method, wherein grid points on the grid are regularly distributed; and
pre-calculating elements of w as a vector of length.

3. The method according to claim 2, further comprising using one of a discrete Fourier transform matrix or a fast Fourier transform for the pre-calculating.

4. The method according to claim 2, further comprising utilizing the model order to indicate the number of radar targets.

5. The method according to claim 2, further comprising utilizing the calculation of a model order as a cost function, so that a cost function exists for each model order.

6. The method according to claim 5, further comprising establishing a maximum of the grid points with the aid of the cost function.

7. The method according to claim 6, further comprising carrying out a post-processing of the maximum by interpolation.

8. The method according to claim 7, further comprising selecting the model order with the interpolated maxima.

9. The method according to claim 1, further comprising storing pre-calculated values in a look-up table.

10. The method according to claim 1, further comprising storing a simplified function for cyclical vectors in a look-up table.

11. A radar sensor for detecting objects for a motor vehicle, which can capture objects in its field of view with the aid of radar targets, wherein the captured radar targets are separated by:
calculating various model orders for a number of the radar targets with a grid-based method, wherein the model orders are interleaved in one another;
specifying a highest model order; and
calculating the highest model order only, wherein results for the lower model orders are produced as partial results of the calculation for the highest model order.

12. The radar sensor according to claim 11, wherein grid points of a grid for the grid-based method are regularly distributed, and wherein elements of w are pre-calculated as a vector of length.

13. The radar sensor according to claim 12, wherein the pre-calculation uses a discrete Fourier transform matrix or a fast Fourier transform.

14. The radar sensor according to claim 12, wherein the model order is utilized to indicate the number of radar targets.

15. The radar sensor according to claim 12, wherein the calculation of a model order is utilized as a cost function, so that a cost function exists for each model order.

16. The radar sensor according to claim 15, wherein a maximum of the grid points is established with the cost function.

17. The radar sensor according to claim 16, wherein a post-processing of the maximum is carried out by interpolation.

18. The radar sensor according to claim 17, wherein the model order is selected with the aid of the interpolated maxima.

19. The radar sensor according to claim 11, wherein pre-calculated values are stored in a look-up table.

20. The radar sensor according to claim 11, wherein a simplified function for cyclical vectors is stored in a look-up table.
